(19) United States
(12) Patent Application Publication
(10) Pub. No.: US 2020/0094720 A1
(43) Pub. Date: Mar. 26, 2020

(54) CONTOURED CUSHION IMPLEMENT AND METHOD

(71) Applicant: Cassidy Cooper, Edmonton (CA)

(72) Inventor: Cassidy Cooper, Edmonton (CA)

(21) Appl. No.: 16/137,538

(22) Filed: Sep. 20, 2018

(51) Int. Cl. B60N 2/90; B60N 2/70

(52) U.S. Cl. CPC B60N 2/986; B60N 2/70

(57) ABSTRACT

A contoured cushion implement for temporary installation on a bench seat of an automobile; the contoured cushion implement includes a contoured cushion having a plurality of recesses with an anatomically forming cushion draped over the contoured cushion. The contoured cushion comprises a soft resilient material forming a substantially triangular body. The plurality of recesses include a bottom recess reciprocally disposed on each of the opposing long sides. The plurality of recesses are configured to accommodate a seat belt mechanism. The anatomically forming cushion is configured to drape over the apex of the contoured cushion. The contoured cushion implement is designed to provide a user with a comfortable surface to rest in an upright reposed position. In a preferred embodiment, the contoured cushion implement placed on the middle seat of a bench seat in an automobile.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### Technical Field

The present invention relates generally to the field of pillows of existing art and more specifically relates to automobile (vehicle) pillows.

### Related Art

Automobiles provide a means of transporting users long distances. Often times, the passengers in the back seat would prefer to sleep on long trips. Presently, passengers must rest against the door of an automobile to relax from an upright position. Doors of an automobile are rigid by design, and do not provide a comfortable surface to rest against. Passengers will bring pillows and other softer items on long trips to find reprieve from the rigid material of the door. The pillows and items may be cumbersome to travel with when they are not in use. Furthermore, the pillows, and other softer items, only form to an extent that many users do not find comfortable. Pillows must further be elevated to provide adequate support to the head and neck of a user. Similar attempts to provide comfort to passengers in an automobile have failed to provide a fully anatomically forming solution. A suitable solution is desired.

U.S. Pat. No. 4,904,021 to Edith R. Clemmer relates to a leaning support for a vehicle seat back. The described leaning support for a vehicle seat back includes a soft, resilient column for use as a cushioned support upon which a passenger in a vehicle may lean. The column is positioned in a vertical direction contiguous to the backrest of a vehicle seat, so that the user may lean sideways against a soft surface while traveling in the vehicle. The column is bendable, and its lower end is tucked into the crevice of the seat to hold the column in its vertical position when the user leans against the column.

### SUMMARY OF THE INVENTION

In view of the foregoing disadvantages inherent in the known automobile pillow art, the present disclosure provides a novel contoured cushion implement and method. The general purpose of the present disclosure, which will be described subsequently in greater detail, is to provide an efficient and effective contoured cushion implement and method.

A contoured cushion implement for temporary installation on a bench seat of an automobile is disclosed herein. The contoured cushion implement includes a contoured cushion having a plurality of recesses with an anatomically forming cushion draped over. The contoured cushion comprises a soft resilient material forming a substantially triangular body. The substantially triangular body has a depth, a front face, a back face, opposing long sides, an apex and, a bottom side. The plurality of recesses include a bottom recess reciprocally disposed on each of the opposing long sides. The plurality of recesses are configured to accommodate a seat belt mechanism. The anatomically forming cushion is configured to drape over the apex of the contoured cushion. The anatomically forming cushion is configured to accommodate at least one user in an upright reposed position. The back face of the contoured cushion is configured to mate with a seat in an automobile to provide a user an anatomically forming cushion to rest against.

According to another embodiment, a method for using a contoured cushion implement is also disclosed herein. The method for using a contoured cushion implement includes a step of providing a contoured cushion implement as described above; a step of, aligning the back face to a middle seat of the bench seat of the automobile; a step of, securing the contoured cushion to the bench seat with the seat belt mechanism; and lastly, an optional step of, resting against the contoured cushion implement.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a contoured cushion implement and method, constructed and operative according to the teachings of the present disclosure.

FIG. 1 is a front view of the contoured cushion implement during an ‘in-use’ condition, according to an embodiment of the disclosure.

FIG. 2 is a front perspective view of the contoured cushion implement of FIG. 1, according to an embodiment of the present disclosure.

FIG. 3 is a front perspective view of the contoured cushion implement of FIG. 1, according to an embodiment of the present disclosure.

FIG. 4 is another view of the contoured cushion implement of FIG. 1, according to an embodiment of the present disclosure.

FIG. 5 is a flow diagram illustrating a method of using the contoured cushion implement, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to an automobile pillow and more particularly to a contoured cushion implement and method as used to improve the use of specialty pillows in vehicles.

Generally, the contoured cushion implement is installed on the back middle seat of an automobile (the device can be used in many land and non-land vehicles). The contoured cushion implement provides a comfortable surface for passengers to lean against. The implement is comprised of two soft members, a substantially triangular contoured cushion and, an anatomically forming cushion. The substantially triangular contoured cushion is designed to securely fit on the middle seat of the bench seating arrangement that is typically found in an automobile. The anatomically forming cushion drapes over the substantially triangular contoured cushion to provide a malleable surface for a user to rest against. The anatomically forming cushion may be of any size and dimension. Further, the anatomically forming cushion may be removable and replaceable. This will allow a user to choose their personal preference of material, fill type, and firmness. Certain embodiments may be modular. The contoured cushion may include various recesses and contours that serve to provide unique resting options. Further, the contoured cushion implement may include an internal semi-rigid frame that will aid in the retention of the implements shape when receiving the weight of a user.

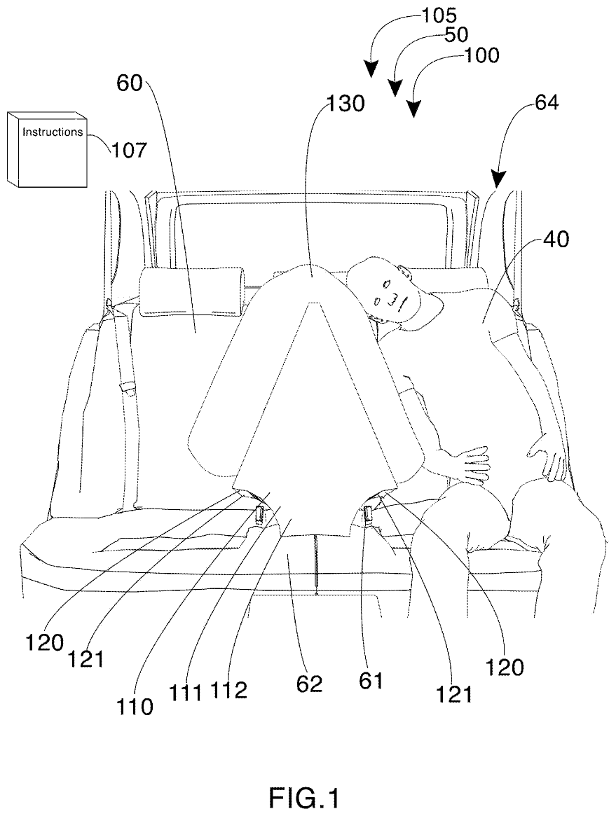

Referring now more specifically to the drawings by numerals of reference, there is shown in FIGS. 1-4, various views of a contoured cushion implement 100.

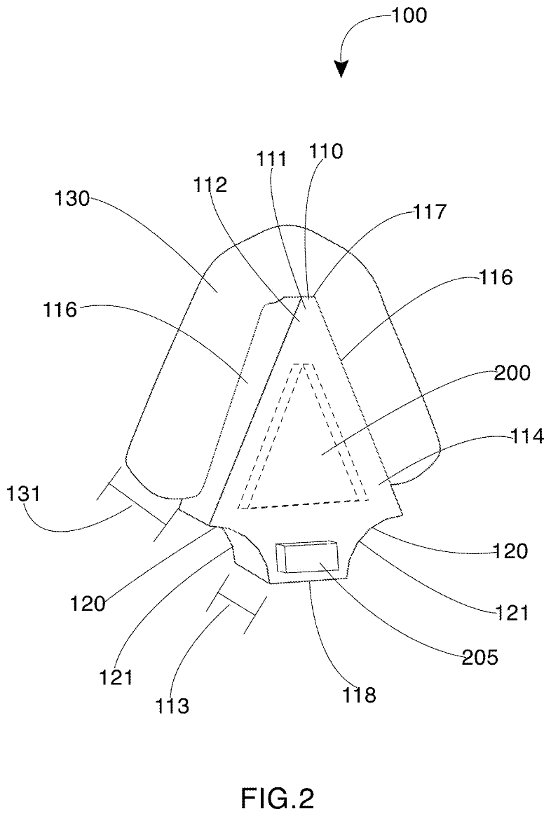

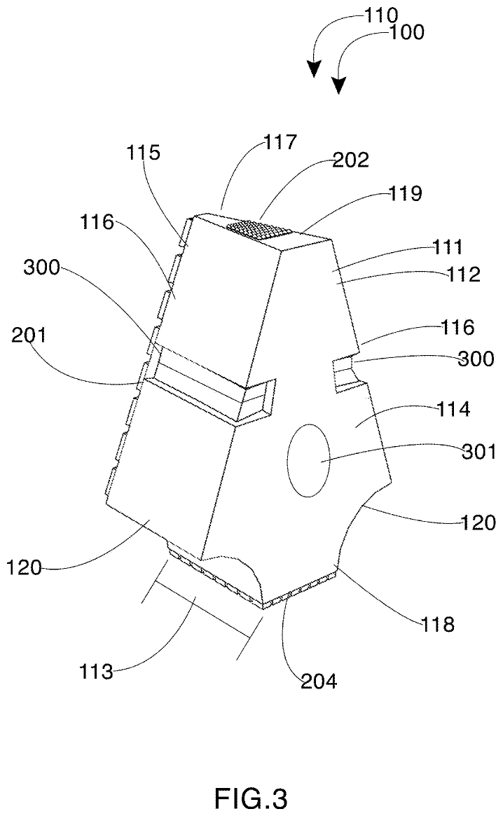

FIG. 1 shows a contoured cushion implement 100 during an ‘in-use’ condition 50, according to an embodiment of the present disclosure. Here, the contoured cushion implement 100 may be beneficial for use by a user 40 to rest against. As illustrated, the contoured cushion implement 100 may include a contoured cushion implement 100 for temporary installation on a middle seat 62 of a bench seat 60 of an automobile 64. The implement includes a contoured cushion 110 comprising a soft resilient material 111 forming a substantially triangular body 112. The substantially triangular body 112 comprises a depth 113 (FIG. 2), a front-face 114 (FIG. 2), a back-face 115 (FIG. 2), opposing long sides 116 (FIG. 2), an apex 117 (FIG. 3) and, a bottom-side 118 (FIG. 2). A plurality of recesses 120 are disposed on the contoured cushion 110. The plurality of recesses 120 include a bottom-recess 121 that is reciprocally disposed on each of the opposing long sides 116 of the substantially triangular body 112. The bottom-recess 121 is configured for accommodating a seat belt mechanism 61. An anatomically forming cushion 130 is configured to drape over the apex 117 of the contoured cushion 110. The anatomically forming cushion 130 is configured to accommodate at least one user 40 in an upright reposed position. The contoured cushion 110 is designed such that the back-face 115 of the contoured cushion 110 is configured to mate with a middle seat 62 of the bench seat 60. The cushion implement provides at least one user 40 an anatomically forming cushion 130 to rest against.

According to one embodiment, the contoured cushion implement 100 may be arranged as a kit 105. In particular, the contoured cushion implement 100 may further include a set of instructions 107. The instructions 107 may detail functional relationships in relation to the structure of the contoured cushion implement 100 such that the contoured cushion implement 100 100 can be used, maintained, or the like, in a preferred manner. Modular versions may be available.

FIG. 2 shows the contoured cushion implement 100 of FIG. 1, according to an embodiment of the present disclosure. As above, the contoured cushion implement 100 may include a contoured cushion 110 comprising a soft resilient material 111 forming a substantially triangular body 112. The substantially triangular body 112 comprises a depth 113, a front-face 114, opposing long sides 116, an apex 117 and, a bottom-side 118. The substantially triangular body 112 includes a plurality of recesses 120. The plurality of recesses 120 includes a bottom-recess 121 that is reciprocally disposed on the opposing long sides 116 of the substantially triangular body 112. The substantially triangular body 112 is configured to be secured to the middle seat 62 (FIG. 1) of a bench seat 60 (FIG. 1) in an automobile 64 (FIG. 1). The substantially triangular body 112 may include a rigid core 200. The rigid core 200 may be used to retain the general shape of the contoured cushion 110 when in use. The contoured cushion 110 may further include a bottom-weight 205 disposed adjacent to the bottom-side 118 of the substantially triangular body 112. The bottom-weight 205 may provide additional downward force against the middle seat 62 for retaining the contoured cushion implement 100 in place. The anatomically forming cushion 130 is configured to be draped over the contoured cushion 110. The anatomically forming cushion 130 may have a diameter 131 that is equal to the depth 113 of the substantially triangular body 112. Further embodiments may include the anatomically forming cushion 130 having a diameter 131 of a disparate size to the depth 113 of the substantially triangular body 112.

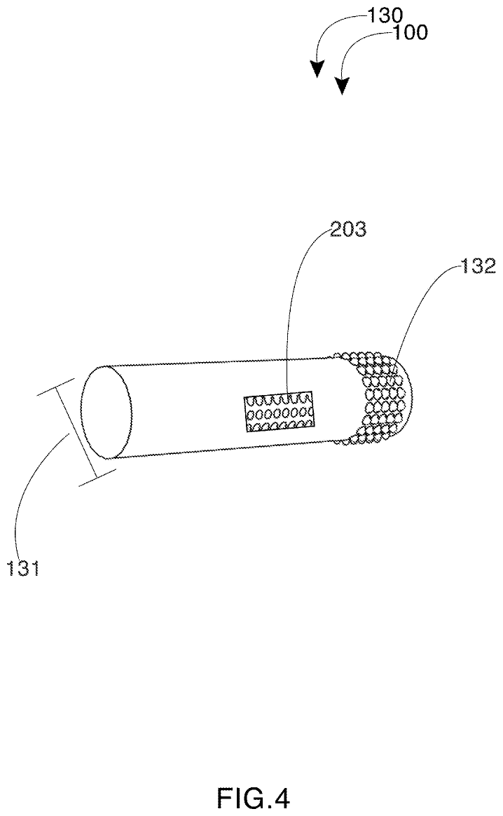

FIG. 3 is another view of the contoured cushion implement 100 of FIG. 1, according to an embodiment of the present disclosure. As shown, the contoured cushion implement 100 includes a contoured cushion 110 comprising a soft resilient material 111. The soft resilient material 111 may comprise memory foam, and alternatively, a similar soft resilient material 111. The contoured cushion 110 comprises a substantially triangular body 112 that has a depth 113, a front-face 114, a back-face 115, opposing long sides 116, an apex 117 and, a bottom-side 118. The contoured cushion 110 may include a back-traction material 201. The back-traction material 201 may be configured to retain the contoured cushion 110 to the bench seat 60 (FIG. 1). As shown, the apex 117 may include a flat-top surface 119 that extends between the opposing long sides 116. The flat-top surface 119 may include a top fastening mechanism 202. The top fastening mechanism 202 may comprise a zipper, hook and loop fasteners, and other further conceived means of fastening. The anatomically forming cushion 130 (FIG. 4) may include a reciprocating fastening mechanism 203 (FIG. 4) configured to mate with the top fastening mechanism 202. Coupling the top fastening mechanism 202 and the reciprocating fastening mechanism 203 may effectively mate the anatomically forming cushion 130 to the contoured cushion 110. As pictured, the bottom-side 118 of the contoured cushion 110 may include a bottom-traction material 204. The bottom-traction material 204 may be configured to retain the contoured cushion 110 to the bench seat 60.

In further embodiments of the implement, the plurality of recesses 120 may include a middle recess 300. The middle recess 300 may be reciprocally disposed on each of the opposing long sides 116 of the substantially triangular body 112. In yet another embodiment, the plurality of recesses 120 may include a front recess 301 disposed on the front-face 114 of the substantially triangular body 112. The optional middle recess 300 and front recess 301 may be useful for aesthetic preferences and comfortability preferences of a user 40 (FIG. 1).

FIG. 4 is another view of the contoured cushion implement 100 of FIG. 1, according to an embodiment of the present disclosure. Shown here is the anatomically forming cushion 130. The anatomically forming cushion 130 may comprise a memory foam material. Alternatively, the anatomically forming cushion 130 may be filled with beads 132. Manufacture materials may vary depending on preference of comfort and aesthetic appeal. In the present embodiment, the anatomically forming cushion 130 is cylindrical. The cylindrical anatomically forming cushion 130 may have a diameter 131 that is equal to that of the depth 113 (FIG. 3) of the substantially triangular body 112 (FIG. 3). However, the diameter 131 may be less than, and alternatively, greater than the depth 113 of the substantially triangular body 112. Further embodiments may include all conceived shapes. Shapes pondered may include, elongate rectangle, elongate ellipse, hollowed conical, semi-rigid including anatomical indentations and, all further conceived sizes and dimensions. Also pictured is a reciprocating fastening mechanism 203 that may be disposed on the anatomically forming cushion 130. The reciprocating fastening mechanism 203 may be a hook and loop fastener, and alternatively, any means of fastening. The reciprocating fastening mechanism 203 may be configured to mate with the top fastening mechanism 202 (FIG. 3) that may be disposed on the apex 117 (FIG. 3) of the substantially triangular body 112. The top fastening mechanism 202 mated with the reciprocating fastening mechanism 203 may effectively attach the anatomically forming cushion 130 to the contoured cushion 110 (FIG. 3). In another embodiment, the anatomically forming cushion 130 may be sewn to the contoured cushion 110.

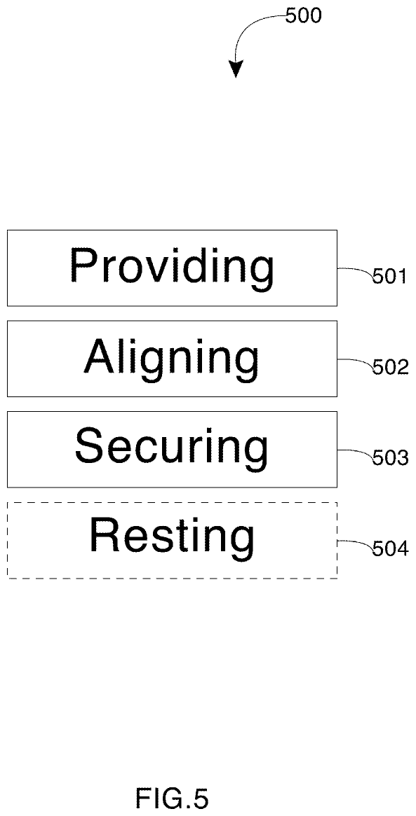

FIG. 5 is a flow diagram illustrating a method 500 for using a contoured cushion implement 100, according to an embodiment of the present disclosure. In particular, the method 500 for using a contoured cushion implement 100 may include one or more components or features of the contoured cushion implement 100 as described above. As illustrated, the method 500 for using a contoured cushion implement 100 may include the steps of: step one 501, providing a contoured cushion implement, the contoured cushion implement comprising: a contoured cushion, the contoured cushion comprising a soft resilient material forming a substantially triangular body, the substantially triangular body comprising a depth, a front-face, a back-face, opposing long sides, an apex and, a bottom-side; a plurality of recesses, the plurality of recesses including a bottom-recess, the bottom-recess reciprocally disposed on each of the opposing long sides of the substantially triangular body, the bottom-recess configured for accommodating a seat belt mechanism; an anatomically forming cushion, the anatomically forming cushion configured to drape over the apex of the contoured cushion, the anatomically forming cushion configured to accommodate at least one user in an upright reposed position; and, wherein the back-face of the contoured cushion is configured to mate with a middle seat of the bench seat thereby providing the at least one user the anatomically forming cushion to rest against; step two 502, aligning the back-face of the contoured cushion to the middle seat of the bench seat of the automobile; step three 503, securing the contoured cushion to the bench seat with the seat belt mechanism; step four 504, resting against the contoured cushion implement;

It should be noted that step 504 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for using 500 a contoured cushion implement 100 are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A contoured cushion implement for temporary installation on a bench seat 60 of an automobile, the implement comprising:
a contoured cushion, said contoured cushion comprising a soft resilient material forming a substantially triangular body, said substantially triangular body comprising a depth, a front-face, a back-face, opposing long sides, an apex and, a bottom-side;
a plurality of recesses, said plurality of recesses including a bottom-recess, said bottom-recess reciprocally disposed on each of said opposing long sides of said substantially triangular body, said bottom-recess configured for accommodating a seat belt mechanism;
an anatomically forming cushion, said anatomically forming cushion configured to drape over said apex of said contoured cushion, said anatomically forming cushion configured to accommodate at least one user in an upright reposed position; and,
wherein said back-face of said contoured cushion is configured to mate with a middle seat of said bench seat thereby providing said at least one user said anatomically forming cushion to rest against.

2. The implement of claim 1, wherein said contoured cushion comprises memory foam.

3. The implement of claim 1, wherein said contoured cushion further comprises a rigid core.

4. The implement of claim 1, wherein said back-face of said contoured cushion includes a back-traction material, said back-traction material configured to retain said contoured cushion to said bench seat.

5. The implement of claim 1, wherein said apex includes a flat-top surface extending between said opposing long sides.

6. The implement of claim 5, wherein said flat-top surface includes a top fastening mechanism.

7. The implement of claim 6, wherein said anatomically forming cushion includes a reciprocating fastening mechanism configured to mate with said top fastening mechanism and secure said anatomically forming cushion to said apex of said contoured cushion.

8. The implement of claim 1, wherein said bottom-side of said contoured cushion includes a bottom-traction material configured to retain said contoured cushion to said bench seat

9. The implement of claim 1, wherein said bottom-side of said contoured cushion includes a bottom-weight, said bottom-weight configured to keep said contoured cushion in an upright position.

10. The implement of claim 1, wherein said plurality of recesses further comprises a middle recess, said middle recess reciprocally disposed on each of said opposing long sides of said substantially triangular body.

11. The implement of claim 1, wherein said plurality of recesses further comprises a front recess, said front recess disposed on said front-face of said substantially triangular body.

12. The implement of claim 1, wherein said anatomically forming cushion is cylindrical.

13. The implement of claim 1, wherein said anatomically forming cushion is sewn to said contoured cushion.

14. The implement of claim 1, wherein said anatomically forming cushion is filled with beads.

15. The implement of claim 12, wherein said anatomically forming cushion has a diameter equal to said depth of said contoured cushion.

16. The implement of claim 1, wherein said anatomically forming cushion comprises memory foam.

17. A contoured cushion implement, the implement comprising:
a contoured cushion, said contoured cushion comprising a soft resilient material forming a substantially triangular body, said substantially triangular body comprising a depth, a front-face, a back-face, opposing long sides, an apex and, a bottom-side,
a plurality of recesses, said plurality of recesses including a bottom-recess, said bottom-recess reciprocally disposed on each of said opposing long sides of said substantially triangular body, said bottom-recess configured for accommodating a seat belt mechanism,
an anatomically forming cushion, said anatomically forming cushion configured to drape over said apex of said contoured cushion, said anatomically forming cushion configured to accommodate at least one user in an upright reposed position, and,
wherein said back-face of said contoured cushion is configured to mate with a middle seat of said bench seat thereby providing said at least one user said anatomically forming cushion to rest against;
wherein said contoured cushion comprises memory foam;
wherein said contoured cushion further comprises a rigid core;
wherein said back-face of said contoured cushion includes a back-traction material, said back-traction material configured to retain said contoured cushion to said bench seat;
wherein said apex includes a flat-top surface extending between said opposing long sides;
wherein said flat-top surface includes a top fastening mechanism;
wherein said anatomically forming cushion includes a reciprocating fastening mechanism configured to mate with said top fastening mechanism and secure said anatomically forming cushion to said apex of said contoured cushion;
wherein said bottom-side of said contoured cushion includes a bottom-traction material configured to retain said contoured cushion to said bench seat;
wherein said bottom-side of said contoured cushion includes a bottom-weight, said bottom-weight configured to keep said contoured cushion in an upright position;
wherein said plurality of recesses further comprises a middle recess, said middle recess reciprocally disposed on each of said opposing long sides of said substantially triangular body;
wherein said plurality of recesses further comprises a front recess, said front recess disposed on said front-face of said substantially triangular body;
wherein said anatomically forming cushion is cylindrical;
wherein said anatomically forming cushion is sewn to said contoured cushion;
wherein said anatomically forming cushion is filled with beads;
wherein said anatomically forming cushion has a diameter equal to said depth of said contoured cushion;
wherein said anatomically forming cushion comprises memory foam;

18. The implement of claim 17, further comprising set of instructions; and
wherein the implement is arranged as a kit.

19. A method of using a contoured cushion implement, the method comprising the steps of:
Providing a contoured cushion implement, said contoured cushion implement comprising: a contoured cushion, said contoured cushion comprising a soft resilient material forming a substantially triangular body, said substantially triangular body comprising a depth, a front-face, a back-face, opposing long sides, an apex and, a bottom-side; a plurality of recesses, said plurality of recesses including a bottom-recess, said bottom-recess reciprocally disposed on each of said opposing long sides of said substantially triangular body, said bottom-recess configured for accommodating a seat belt mechanism; an anatomically forming cushion, said anatomically forming cushion configured to drape over said apex of said contoured cushion, said anatomically forming cushion configured to accommodate at least one user in an upright reposed position; and, wherein said back-face of said contoured cushion is configured to mate with a middle seat of said bench seat thereby providing said at least one user said anatomically forming cushion to rest against;
aligning said back-face of said contoured cushion to said middle seat of said bench seat of said automobile;
securing said contoured cushion to said bench seat with said seat belt mechanism;

20. The method of claim 19, further comprising the step of:
resting against said contoured cushion implement;
